(19) United States
(12) Patent Application Publication
(10) Pub. No.: US 2005/0063331 A1
(43) Pub. Date: Mar. 24, 2005

(54) Apparatus and method for transmitting wakeup channel for mode transition in sleeping state in a broadband wireless communication system

(75) Inventors: So-Hyun Kim, Suwon-si (KR); Hyun-Jeong Kang, Seoul (KR); Sung-Jin Lee, Suwon-si (KR); Yeong-Moon Son, Anyang-si (KR); Jung-Je Son, Seongnam-si (KR); Chang-Hoi Koo, Seongnam-si (KR)

Correspondence Address: DILWORTH & BARRESE, LLP, 333 EARLE OVINGTON BLVD., UNIONDALE, NY, 11553, US

(73) Assignee: SAMSUNG ELECTRONICS CO., LTD., GYEONGGI-DO (KR)

(21) Appl. No.: 10/945,506

(22) Filed: Sep. 20, 2004

(30) Foreign Application Priority Data
Sep. 20, 2003 (KR) 65389/2003

(51) Int. Cl. H04Q 7/00

(52) U.S. Cl. 370/328; 370/478

(57) ABSTRACT

A method and apparatus for transmitting a DL-WUCH for a mode transition in a sleeping state in a broadband wireless communication system are provided. In the broadband wireless communication system, a base station (BS) transmits control information to a plurality of subscriber stations (SSs) on a common control channel. To demodulate a control channel signal received from the BS, an SS receives a wakeup channel signal which indicates whether the control channel signal includes control information for the SS, reads a wakeup channel indicator at a predetermined position assigned to the SS of the wakeup channel signal, and determines whether to demodulate the control channel signal according to the wakeup channel indicator.

### PRIORITY

This application claims priority under 35 U.S.C. § 119 to an application entitled “Apparatus and Method for Transmitting Wakeup Channel for Mode Transition in Sleeping State in a Broadband Wireless Communication System” filed in the Korean Intellectual Property Office on Sep. 20, 2003 and assigned Serial No. 2003-65389, the contents of which are incorporated herein by reference.

### BACKGROUND OF THE INVENTION

1. Field of the Invention

The present invention relates generally to a broadband wireless access (BWA) communication system, and in particular, to an apparatus and method for transmitting a wakeup channel for state transition in a sleeping state in an orthogonal frequency division multiple access (OFDMA) mobile communication system.

2. Description of the Related Art

Research is being pursued to provide a quality of service (QoS) yielding about 100 Mbps to users in upcoming fourth generation (4G) communication systems. The existing third generation (3G) communication systems support about 384 kbps in a relatively poor channel environment (e.g. an outdoor environment), and up to 2 Mbps in a relatively good channel environment (e.g., an indoor environment)

Meanwhile, wireless local area network (LAN) and wireless metropolitan area network (MAN) systems typically support a data rate of 20 Mbps to 50 Mbps. Thus, the 4G communication systems are being developed toward deployment of the wireless LAN and MAN systems with guarantee of mobility and QoS. In this context, research is being actively pursued to develop communication systems supporting high-speed service intended for 4G communications.

A typical BWA communication system and its operation will be described below with reference to FIG. 1.

The wireless MAN system is a type of BWA communication system. It services a wider area and supports a higher data rate than the wireless LAN system. The IEEE (Institute of Electrical and Electronics Engineers) 802.16a communication system was designed by applying orthogonal frequency division multiplexing (OFDM) and OFDMA to the physical channel of the wireless MAN system for broadband network implementation.

That is, the IEEE 802.16a communication system is a BWA communication system using OFDM/OFDMA. Due to the use of OFDM/OFDMA, the IEEE 802.16a communication system enables high-speed data transmission by transmitting physical channel signals on multiple subcarriers. The IEEE 802.16e communication system is an extension of the IEEE 802.16a communication system. The IEEE 802.16e communication system is yet to be fully specified.

Both the IEEE 802.16a and IEEE 802.16e communication systems are OFDM/OFDMA-BWA communication systems. For notational simplicity, the IEEE 802.16a communication system will be taken as an example of a BWA communication system. While it is clear that the IEEE 802.16a and IEEE 802.16e communication systems may adopt a single carrier scheme instead of OFDM/OFDMA, only OFDM/OFDMA will be discussed below.

Referring to FIG. 1, the IEEE 802.16a communication system is configured to have a single cell structure. It comprises a base station (BS) 100 and a plurality of subscriber stations (SSs) 110, 120 and 130 under management of the BS 100. OFDM/OFDMA is used for signal transmission and reception between the BS 100 and the SSs 110, 120 and 130.

Although the wireless MAN system is suitable for high-speed communication due to its advantages of wide coverage and high data rate, it gives no regard to the mobility of SSs and thus its entailing handoff. Therefore, there is a need for specifying the operation of the medium access control (MAC) layer to minimize the power consumption of a fast moving SS and supporting an operation for high-speed data transmission between a BS and an SS.

The MAC layer operational states so far discussed for the BWA communication system will be described below. Control of the MAC layer must be carried out in the manner that ensures the mobility of SSs and minimizes their power consumption.

Before describing the MAC layer operational states, therefore, new downlink (DL) channels and uplink (UL) channels proposed to support the MAC layer operational states will first be described.

Table 1 below lists the proposed DL channels.

TABLE 1

| PHY | Usage | Channel type |
|---|---|---|
| Pilot channel (DL-PICH) | Cell identification and sync | Common |
| | acquisition | channel |
| Broadcast control channel | System information | Common |
| (DL-BCCH) | transmission | channel |
| Traffic channel (DL-TCH) | Burst traffic channel | Time- |
| | (burst traffic transmission) | shared |
| | Dedicated traffic channel | Fixed |
| | (fixed assignment) | assignment |
| | Signaling channel | Dedicated |
| | | channel |
| Traffic control channel (DL- | DL-TCH-associated control | Common |
| TCCH) | information transmission | channel |

The above DL-channels are used as follows.

(1) DL-PICH

The DL-PICH is used for cell identification and sync acquisition between a BS and an SS. After power-on, the SS receives DL-PICH signals from a plurality of BSs and determines a BS having a DL-PICH with the highest carrier to interference and noise ratio (CINR) as its serving BS.

(2) DL-BCCH

The DL-BCCH delivers system configuration information, neighbor cell information, DL and UL channel configuration information, DL and UL access information, and paging information indicating that a particular SS has been paged in the BWA communication system.

When the system configuration information, the neighbor cell information, the DL and UL channel configuration information, or the DL and UL access information is changed, the BS periodically updates the changed information and notifies the SS of the update via the DL-BCCH. The DL-BCCH also delivers a response message for an uplink access. The DL-BCCH is transmitted periodically in super frames, each made up of a predetermined number of frames.

(3) DL-TCH

The DL-TCH delivers actual packet data. Depending on the characteristics of the packet data, three logical channels can be mapped to the DL-TCH. Traffic channels are also existent on the uplink.

i) Burst Traffic Channel

The burst traffic channel is a logical channel that transmits burst traffic. The burst traffic is transmitted in a time-sharing scheme that provides burst-based dynamic allocation based on dynamic scheduling. Real-time service data and/or non-real-time service data is scheduled and transmitted via the burst traffic channel. Or best effort packet data is transmitted via the burst traffic channel.

ii) Dedicated Traffic Channel

The dedicated traffic channel assigns a minimum bandwidth fixedly with priority. Service data to which a minimum bandwidth is continuously assigned such as unsolicited granted service (UGS) is delivered via the dedicated traffic channel.

iii) Signaling Channel

The signaling channel delivers control information in a signaling message.

(4) DL-TCCH

The DL-TCCH transmits control information associated to the DL-TCH for use in effectively processing data received on the DL-TCH in the SS. The DL-TCCH is transmitted all the time in conjunction with the DL-TCH. The control information of the DL-TCCH includes data coding information of the DL-DCH data (e.g., information about an adaptive modulation and coding (AMC) scheme and an encoded packet (EP) size, and a MAC control message). The BS may feed back AMC information about uplink packet data to the SS via the DL-TCCH.

Table 2 below lists the UL channels.

TABLE 2

| PHY | Usage | Channel type |
|---|---|---|
| Access channel (UL-ACH) | Contention-based uplink | Common |
| | access | channel |
| | Contention-free uplink access | Common |
| | | channel |
| Traffic channel (UL-TCH) | Burst traffic channel | Time- |
| | | shared |
| | Dedicated traffic channel | Fixed |
| | | assignment |
| | Signaling channel | Dedicated |
| | (signaling message | channel |
| | transmission) | |

(1) UL-ACH

The UL-ACH is used for the SS to transmit a bandwidth allocation request signal for uplink access to transmit uplink packet data. Depending on the class of the SS or the characteristic of the uplink data, the following two logical channels can be mapped to the UL-ACH.

i) Access Channel

The access channel is used for contention-based uplink access. The SS transmits on the access channel for network entry or for requesting a bandwidth assignment. Short data such as a transmission control protocol (TCP) ACK/NACK signal can be transmitted along with an uplink access request signal via the access channel (e.g., access preamble+packet data).

ii) Fast Access Channel

The fast access channel is used for contention-free uplink access. The SS is assigned an orthogonal code for use in uplink access, for example, a pseudo-random noise code or a time slot position from the BS, and attempts an uplink access using the orthogonal code or the time slot position.

(2) UL-TCH

The SS transmits data to the BS via the UL-TCH. Depending on the characteristic of the data of the UL-TCH, the following three logical channels can be mapped to the UL-TCH. Traffic channels are also existent on the downlink.

i) Burst Traffic Channel

The burst traffic channel is identical in function to that mapped to the DL-TCH except that it is mapped to the UL-TCH rather than to the DL-TCH.

ii) Dedicated Traffic Channel

The dedicated traffic channel is identical in function to that mapped to the DL-TCH except that it is mapped to the UL-TCH rather than to the DL-TCH.

iii) Signaling Channel

The signaling channel is identical in function to that mapped to the DL-TCH except that it is mapped to the UL-TCH rather than to the DL-TCH.

With reference to FIG. 2, a description will be made of the MAC layer operational states in which operations are actually performed using the DL and UL channels of the BWA communication system which are illustrated in Table 1 and Table 2.

Referring to FIG. 2, five operational states are defined at the MAC layer in the now proposed BWA communication system: a null state 211, an initialization state 213, a sleeping state 215, an access state 217, and a traffic state 219. The MAC layer operational states are so configured as to minimize the power consumption of SSs and support high-speed packet transmission operations between a BS and an SS.

The MAC layer operational states will be described in brief.

Null State

The null state 211 is a state where an SS is initialized because of a power-on or an abnormal resetting. State transition can occur from any of the initialization state 213, the sleeping state 215, the access state 217, and the traffic state 219 to the null state 211. When the SS is initialized successfully, it transits from the null state 211 to the initialization state 213.

Initialization State

After the initialization, the SS acquires synchronization with a BS in the initialization state 213. For sync acquisition, the SS monitors predetermined frequency bands and detects a DL-PICH signal having the greatest CINR. At a handoff from an old BS to a target BS, the SS acquires synchronization with the target BS in the initialization state 213.

Meanwhile, because the IEEE 802.16a communication system, which is a BWA communication system, does not consider the mobility of the SS, only the power-on or reset of the SS is considered. On the other hand, because the IEEE 802.16e communication system takes the mobility of the SS into account, handoff as well as the power-on or reset is considered in the IEEE 802.16e communication system.

Therefore, the SS continuously monitors the DL-PICH signals to determine whether there is a BS that transmits a DL-PICH signal having a higher CINR than that of the serving BS. If there is, the SS performs a cell reselection operation.

After the SS acquires synchronization, the SS receives system information (SI) by a DL-BCCH signal, and carries out a network entry operation for registration and authentication to the BS. After preparing for normal packet data transmission/reception with the BS, the SS transits to one of the sleeping state 215, the access state 217, and the traffic state 219.

The SI includes system configuration information, neighbor cell information, DL and UL channel configuration information, and DL and UL access information, as described above with reference to Table 1 and Table 2.

If the SS loses synchronization with the BS in the initialization state 213 due to some problem such as a system error, it transits to the null state 211 to repeat the initialization. That is, when the SS is reset because of problems such as a system error, it starts again in the null state 211. In the case where the SS receives paging information indicating the presence of DL data destined for the SS after the network entry operation for registration and authentication to the BS, it transits from the initialization state 213 to the traffic state 219.

The operation of the SS in the initialization state 213 are summarized as follows:
(1) The SS monitors DL-PICH signals and acquires synchronization with the BS;
(2) The SS monitors DL-BCCH: it receives system configuration information, neighbor cell information, DL and UL channel configuration information, DL and UL access information, and paging information indicating that the SS is paged;
(3) The SS performs a network entry operation for registration and authentication to the BS: it accesses the BS via the UL-ACH and receives a response signal for uplink access via the DL-BCCH in the network entry operation.

Sleeping State

In the absence of data to be sent to, or received from, the BS after the network entry operation in the initialization state 213, the SS transits to the sleeping state 215 to minimize its power consumption.

If the SS receives paging information during the monitoring of the DL-BCCH in the sleeping state 215, it transits to the traffic state 219 to receive data from the BS.

Meanwhile, if the SS loses synchronization with the BS due to such a problem such as a system error while in the sleeping state 215, it transits to the null state 211 for initialization. That is, when the SS is reset due to a problem such as a system error, it must start again in the null state 211.

The sleeping state 215 is branched into an awake mode and a sleeping mode. These modes will be described later.

Access State

In the presence of data to be sent to or received from the BS after the network entry operation in the initialization state 213, the SS transits to the access state 217. In the access state 217, the SS accesses the BS.

The access to the BS in the access state 217 is based on contention. The SS requests a bandwidth assignment to the BS in order to transmit data, that is, traffic to the BS. The contention-based uplink access is carried out via the UL-ACH. If there is an available bandwidth, the BS assigns a bandwidth to the SS and transmits information about the assigned bandwidth to the SS via the DL-BCCH.

Recognizing the bandwidth assignment, the SS transits from the access state 217 to the traffic state 219. On the other hand, if the SS fails to be assigned the bandwidth despite the bandwidth assignment request, the SS transitions from the access state 217 to the sleeping state 215.

After a bandwidth assignment failure, the SS may request the bandwidth assignment again. If bandwidth is not assigned to the SS within a predetermined time period, the SS transits from the access state 217 to the sleeping state 215. Aside from the access failure, when the data transmission is cancelled, the SS transits from the access state 217 to the sleeping state 215.

In the case where the SS loses synchronization with the BS due to a problem such as a system error during the access, it transits from the access state 217 to the null state 211 for initialization. That is, when the SS is reset because of a problem such as a system error, it starts again in the null state 211.

Traffic State

In the traffic state 219, the SS exchanges data with the BS. Even if the SS does not transmit or receive data directly to or from the BS, resources have been assigned for future data transmission/reception. That is, albeit the absence of data to be sent or received between the SS and the BS, since the resources for data transmission and reception have already been assigned, the SS can fast access the BS upon generation of data to be sent or received and thus data transmission and reception is normally carried out.

When there is no more data to be sent or received between the SS and the BS, or it is necessary to reduce the power consumption of the SS in the traffic state 219, the SS transits to the sleeping state 215.

In the case where the SS loses synchronization with the BS due to a problem such as a system error while in the traffic state 219, it transits to the null state 211 for initialization. That is, when the SS is reset because of a problem such as a system error, it starts again in the null state 211.

The sleeping state 215 can be divided into an awake mode and a sleeping mode. These operational modes will be described with reference to FIG. 3.

Referring to FIG. 3, two operational modes are defined in the sleeping state 215: a sleeping mode 300 and an awake mode 350.

When the SS enters the network successfully, it transits from the initialization state 213 to the sleeping state 215 in step 311. In the case where the SS loses synchronization with the BS due to such a problem such as a system error while in the sleeping state 215, it transits to the null state 211 for initialization in step 313. Upon the state transition from the initialization state 213 to the sleeping state 215, it enters into either the sleeping mode 300 in step 317, or the awake mode 350 in step 315.

In the absence of data to be received in the sleeping mode 300, the SS does not perform a demodulation to reduce power consumption and listens to the DL-BCCH from the BS, and stays awake for a predetermined listening interval. In the awake mode 350, the SS listens to the DL-BCCH from the BS. As described above, since the BS wakes up the SS due to SI updating, or to transmit paging information upon generation of data to be sent, the SS monitors the DL-BCCH signal to receive the SI update or to detect the presence or absence of the paging information.

If the DL-BCCH signal indicates an SI update, the SS finds the updated SI and transits from the awake mode 350 to the sleeping mode 300 in step 317. If the DL-BCCH signal indicates the presence of paging information for the SS, the SS transits from the awake mode 350 to the traffic mode 219 in step 325.

Meanwhile, in the presence of data to be sent to the BS, the SS transits from the awake mode 350 to the access state 217 for a contention-based uplink access in step 319. When the uplink access is failed after an access attempt for a predetermined time period, the SS transits from the access state 217 to the sleeping state 215 in step 321. Also when data transmission is canceled, the SS transits from the access state 217 to the sleeping state 215. If there is no more data to be sent or received, or it is necessary to reduce the power consumption of the SS, the SS transits from the traffic state 219 to the sleeping state 215 in step 323.

The state transition of the SS proposed at the present time for the BWA communication system has been described above.

In the conventional BWA communication system, control information is transmitted in a MAC message, DL_MAP or UL_MAP. The MAC message is positioned at the front part of each frame. The SS receives the MAC message in each frame and acquires downlink or uplink control information. A frame containing the control information is typically 2 to 10 ms in duration. Even if there is no data to be sent or received, the SS wakes up every 2 to 10 ms to receive the DL_MAP or UL_MAP message.

In the 2G and 3G mobile communication networks, the DL-BCCH is a physical channel. The SS acquires control information and SI by continuously monitoring the DL-BCCH. The SS searches for its cell and acquires synchronization with the cell. It receives basic control information and SI from the DL-BCCH. Even when a call is not set up or there is no data to be sent or received, the SS continuously monitors the DL-BCCH. The frame structure of the DL-BCCH that the BS transmits to the SS in the awake mode will be described with reference to FIG. 4.

Referring to FIG. 4, the BS transmits the DL-BCCH to the SS. The DL-BCCH includes system configuration information, neighbor cell information, DL and UL channel configuration information, DL and UL access information, and paging information indicating that the SS is paged.

The DL-BCCH is transmitted typically on the basis of a super frame 410 (e.g., having a duration of 76.8 ms) having a plurality of frames (e.g., 64 frames) in order to save power. Therefore, the SS transits to the awake mode 420 each super frame and monitors the DL-BCCH to determine whether there is any control information for the SS.

The 4G system now under consideration uses the DL control channels illustrated in Table 1. The DL control channels include the DL-BCCH including initial SI and frame control information before a call setup, and the DL-TCCH including traffic control information and scheduling information after the call setup.

As described above, the SS continuously monitors the DL-BCCH before a call setup and the DL-TCCH after the call setup, for control information and other information. That is, the SS continuously monitors the DL-BCCH in the sleeping state in the conventional BWA communication system. The conventional 3G mobile communication system is also configured to make the SS monitor the paging channel continuously.

Although the sleeping state is defined to prevent unnecessary power consumption of the SS in the BWA communication system, the SS receives and demodulates the DL-BCCH in each frame or in each super frame despite the absence of information for the SS, which results in unnecessary power consumption.

### SUMMARY OF THE INVENTION

An object of the present invention is to substantially solve at least the above problems and/or disadvantages and to provide at least the advantages below. Accordingly, an object of the present invention is to provide a method and apparatus for minimizing the power consumption of an SS by minimizing the time an SS spends monitoring a channel including control information while in a sleeping state in a BWA communication system.

Another object of the present invention is to provide a frame structure for supporting the transition of an SS and a BS between a sleeping mode and an awake mode in a sleeping state.

A further object of the present invention is to provide a method and apparatus for processing a call between an SS and a BS through a transition between a sleeping mode and an awake mode in a sleeping state in a BWA communication system.

Still another object of the present invention is to provide a method and apparatus for transmitting a downlink wakeup channel suitable for use in an OFDMA BWA communication system.

Yet another object of the present invention is to provide a method and apparatus for efficiently processing a call using a wakeup channel for transition between an awake mode and a sleeping mode while in a sleeping state.

The above objects are achieved by providing a method and apparatus for transmitting a DL-WUCH (downlink wake-up channel) for mode transition in a sleeping state in a BWA communication system.

According to one aspect of the present invention, there is provided a method of demodulating a control channel signal received from the BS in an SS in a broadband wireless communication system including a plurality of subscriber stations (SSs) and a base station (BS) that transmits control information to the SSs on a common control channel. The method comprises the steps of receiving a wakeup channel signal indicating whether the control channel signal includes control information for the SS; reading a wakeup channel-indicator (WUI) at a predetermined position within the wakeup channel signal; determining whether to demodulate the control channel signal according to information contained in the WUI.

According to another aspect of the present invention, there is provided an apparatus for transmitting the control channel signal in the BS in an orthogonal frequency division multiple access (OFDMA) broadband wireless communication system where, in the absence of data to be sent between a base station (BS) and subscriber stations (SSs), the BS transmits a common control channel signal to the SSs every predetermined period in a sleeping state. The apparatus comprises a time-division multiplexer for time-multiplexing the control channel signal and a wakeup channel signal indicating whether the control channel signal includes control information for the SSs and outputting the time-multiplexed signals; a controller for controlling the time-division multiplexer to selectively output the control channel signal and the wakeup channel signal at predetermined time points; and an inverse fast Fourier transformer for inverse-fast-Fourier-transforming the control channel signal and the wakeup channel signal selectively received from the time-division multiplexer by mapping the received signal to a plurality of subcarriers.

According to a further aspect of the present invention, there is provided an apparatus for transmitting the control channel signal in the BS, in an orthogonal frequency division multiple access (OFDMA) broadband wireless communication system where in the absence of data to be sent between a base station (BS) and subscriber stations (SSs), the BS transmits a common control channel signal to the SSs every predetermined period in a sleeping state. The apparatus comprises an inverse fast Fourier transformer for inverse-fast-Fourier-transforming the control channel signal and a wakeup channel signal by mapping the control channel signal and the wakeup channel signal to different subcarriers, each to at least one subcarrier.

### BRIEF DESCRIPTION OF THE DRAWINGS

The above and other objects, features and advantages of the present invention will become more apparent from the following detailed description when taken in conjunction with the accompanying drawings in which:

FIG. 1 illustrates the configuration of a typical BWA communication system;

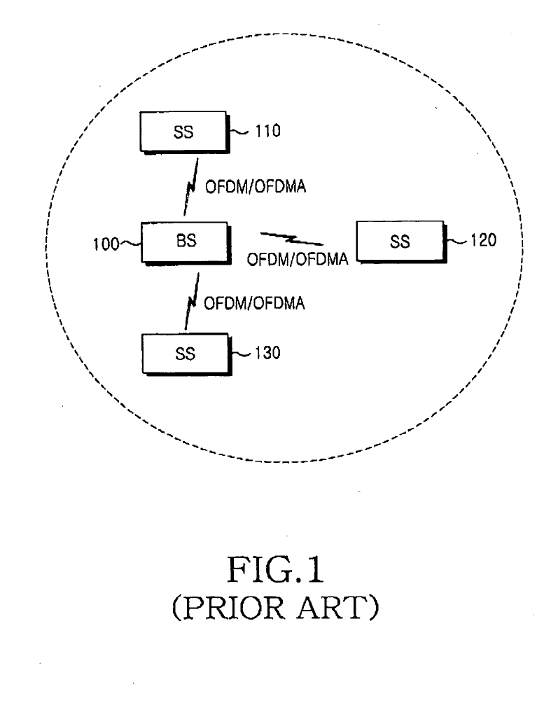

FIG. 2 is a state transition diagram in a MAC layer of the typical BWA communication system;

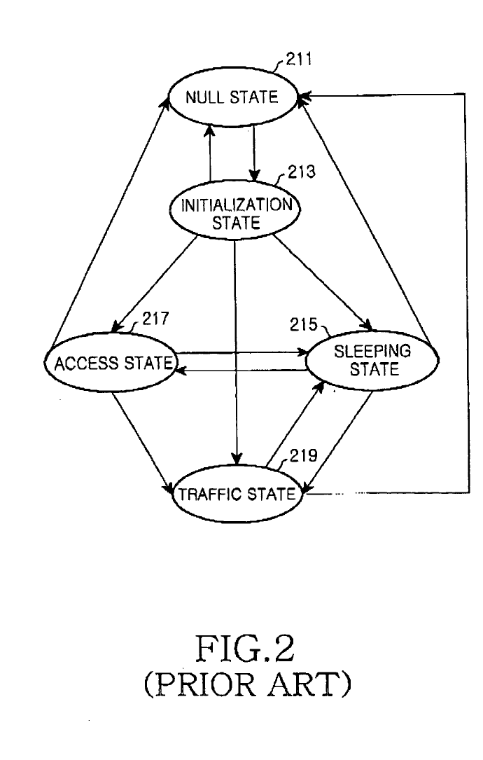

FIG. 3 illustrates the operational modes of a sleeping state illustrated in FIG. 2;

FIG. 4 illustrates the frame structure of a DL-BCCH that a BS transmits to an SS in an awake mode;

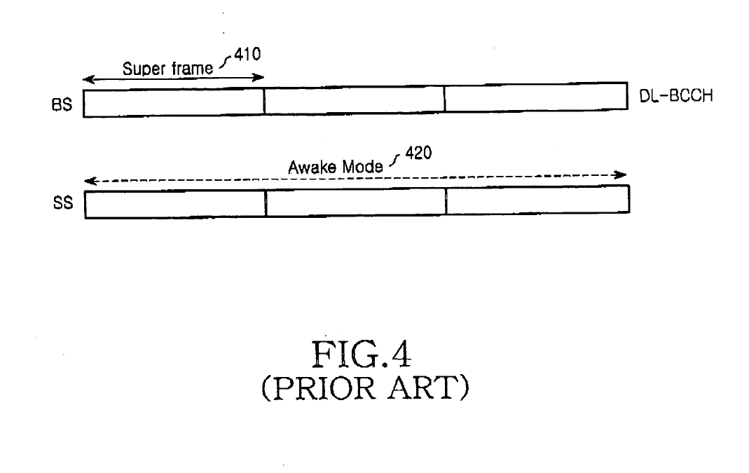

FIG. 5 illustrates a frame structure including a control channel and a traffic channel distinguished by subchannels in an OFDMA scheme according to the present invention;

FIG. 6 is a flowchart illustrating a mode transition procedure in the sleeping state according to the present invention;

FIG. 7 illustrates a frame structure in which a DL-WUCH and a DL-BCCH are time-multiplexed in an OFDMA scheme according to an embodiment of the present invention;

FIG. 8 illustrates mode transition of the SS in the sleeping state according to an embodiment of the present invention;

FIG. 9 illustrates a frame structure in which the DL-WUCH and the DL-BCCH are frequency-multiplexed in an OFDMA scheme according to another embodiment of the present invention;

FIG. 10 illustrates mode transition of the SS in the sleeping state according to the second embodiment of the present invention;

FIG. 11 is a block diagram of a DL-WUCH transmitter in the BS according to the first embodiment of the present invention; and

FIG. 12 is a block diagram of a DL-WUCH transmitter in the BS according to the second embodiment of the present invention.

### DETAILED DESCRIPTION OF THE PREFERRED EMBODIMENTS

Preferred embodiments of the present invention will be described herein below with reference to the accompanying drawings. In the following description, well-known functions or constructions are not described in detail since they would obscure the invention in unnecessary detail.

The present invention is intended to minimize the power consumption of an SS by minimizing the time required to monitor a channel containing control information, DL-BCCH in a sleeping state defined in a BWA communication system. Also, the present invention proposes a wakeup channel for controlling the demodulation of the DL-BCCH and provides a method of effectively transmitting the wakeup channel in an OFDM/OFDMA communication system.

The present invention is not limited to the OFDM/OFDMA BWA communication system and it is applicable to any system that transmit SI on a control channel before a communication channel is established between a BS and an SS.

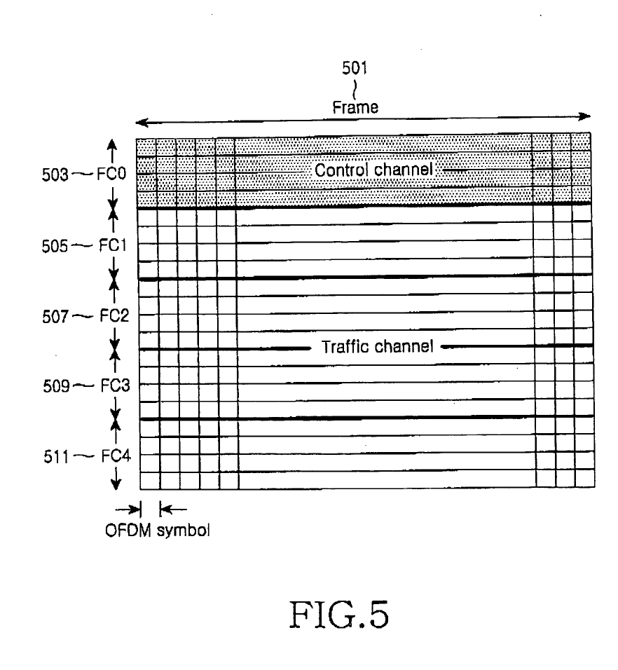

With reference to FIG. 5, the frame structure of an OFDM/OFDMA system to which the present invention is applied will be described below.

Referring to FIG. 5, a single frame 501 may include a plurality of OFDM symbols. The horizontal axis represents time and the vertical axis represents frequency. Each OFDM symbol is plotted on the horizontal axis and each subcarrier on the vertical axis.

One or more subcarriers form a frame cell (FC). In the case illustrated in FIG. 5, four subcarriers form one FC. The subcarriers of an OFDM frame are grouped into frame cells FC0 503 to FC4 511. A plurality of channels can be assigned to one or more FCs. A control channel is assigned to FC0 503 and traffic channels to FC1 505, FC2 507, FC3 509 and FC4 511. That is, one OFDM frame is comprised of one control channel and four traffic channels.

The frame is configured such that some of the subcarriers are assigned for the control channel and the other subcarriers for the traffic channels. Before a call setup, the SS monitors the subcarriers corresponding to the control channel. When the SS acquires information about the call setup and data transmission/reception from the control channel, it transmits and/or receives data on the traffic channels.

Hereinbelow, a description is made of a method of monitoring the control channel with minimum power consumption by the SS before a call setup or in the case of non-data transmission and/or reception according to the present invention.

According to the present invention, a new channel is defined in a part of the control channel, for notifying the SS whether the control channel includes control information for the SS, and thus the SS determines whether or not to demodulate the control channel by the new channel.

As previously described, SI parameters or information about the DL-TCCH is acquired via the DL-BCCH, and after a traffic channel is established, downlink scheduling information is acquired via the DL-TCCH in the OFDM/OFDMA system.

Before the establishment of the traffic channel, therefore, the SS monitors the DL-BCCH and after the establishment of the traffic channel, it monitors the DL-TCCH. Considering that control information for the SS does not always exist in such a control channel, it is preferable to monitor the control channel only when the control information is changed or new control information is constructed, rather than to monitor the control channel continuously, in order to minimize power consumption. A new channel is designed to effectively control monitoring of the control channel. This channel is called a downlink wakeup channel (DL-WUCH).

Table 3 below tabulates DL control channels including the DL-WUCH.

TABLE 3

| PHY | MAC | Usage | Channel type |
|---|---|---|---|
| Broadcast control | — | System information | Common |
| channel (DL-BCCH) | | and frame control | channel |
| | | information | |
| Traffic control | — | Downlink traffic | Common |
| channel (DL-TCCH) | | control information | channel |
| | | and downlink | |
| | | scheduling | |
| | | information | |
| Wakeup channel (DL- | — | Awake mode | Common |
| WUCH) | | indication | channel |

Referring to Table 3, the DL-WUCH is proposed to minimize the power consumption of the SS. The SS monitors the DL-WUCH in the sleeping mode of the sleeping state. A wakeup indicator (WUI) is positioned in a predetermined part of the DL-WUCH. Depending on whether the WUI indicates an on or off value the SS transitions from the sleeping mode to the awake mode. If the WUI is on, this implies that the WUI is set to a first predetermined value, for example “1”. On the contrary, if the WUI is off, this implies that the WUI is set to a second predetermined value, for example “0”. Preferably, the DL-WUCH is transmitted in a super frame.

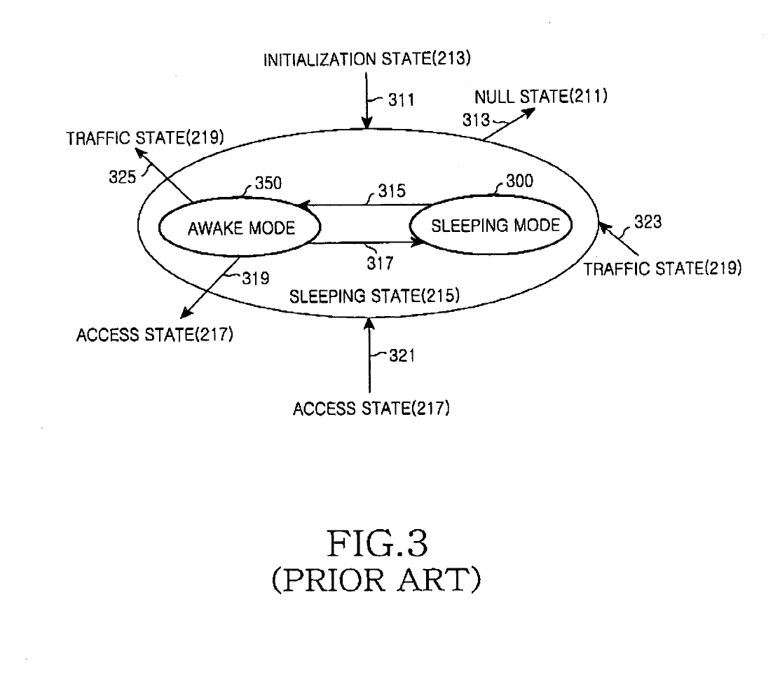

As illustrated in FIG. 3, the sleeping mode and the awake mode are defined in the sleeping state. Before a call setup or in the absence of data to be transmitted or received, the SS enters into the sleeping state. If a call is to be set up, or upon generation of data to be sent or received, the SS transits to the access state or the traffic state. Information needed to transition from the sleeping state to the access state or the traffic state is set in the DL-BCCH.

That is, even in the sleeping state, the SS must monitor the DL-BCCH for mode transition and state transition irrespective of presence or absence of control information for the SS. In the present invention, however, the SS receives the DL-BCCH only in the presence of control information for the SS, thereby minimizing power consumption.

For this purpose, the DL-WUCH is inserted to notify, the SS whether there is control information for the SS. The SS receives the DL-BCCH only when the DL-WUCH indicates the presence of the control information destined for the SS, and reads the DL-BCCH when necessary.

The DL-WUCH controls the mode transition and thus, minimizes the power required to monitor the control channel. Therefore, the sleeping mode where the SS receives no channels and the awake mode where the SS reads the DL-WUCH or the DL-BCCH are defined in the sleeping state.

FIG. 3 illustrates mode transition of the SS between the sleeping mode and the awake mode in the sleeping state. After an initial cell search, the BS tells each SS its assigned position in the DL-WUCH. At the assigned position in the DL-WUCH, a WUI is set for the SS.

There are several ways for the BS to notify the SS of the position of the WUI. For example, the notification can be made using a MAC message on the DL-BCCH, or by indicating the mapping relation between a WUI position and a connection identifier (CID) and sending this information to the SS.

Notifying the SS of the position of the WUI using a MAC message on the DL-BCCH will first be addressed. In accordance with this method, a bit indicating the index of a frame and the index of a slot in the frame is inserted in the MAC message. For example, if the WUI is set in the 3^{rd} slot of an 11^{th} frame in the DL-WUCH, the position of the WUI can be expressed in hexa-decimal, 0xB3.

Alternatively, if the BS notifies the SS of the position of a WII by indicating a mapping relation between a WUI position and a CID, since each SS is identified by a CID, a WUI having the same address as the CID is assigned to the SS so that the SS can find the position of its WUI. For example, if the CID is equal to hexa-decimal 0x43C7, and the last two digits of the CID are the address of the WUI, the SS finds out that its WUI is at the 7^{th} slot of the 12^{th} frame.

According to the present invention, the SS reads the DL-WUCH to determine whether the DL-BCCH has control information for the SS. Specifically, the SS reads data at a position assigned to the SS in the DL-WUCH. The data is a WUI. Depending on whether the WUI indicates on or off setting, the SS can determine whether the DL-BCCH contains control information for the SS.

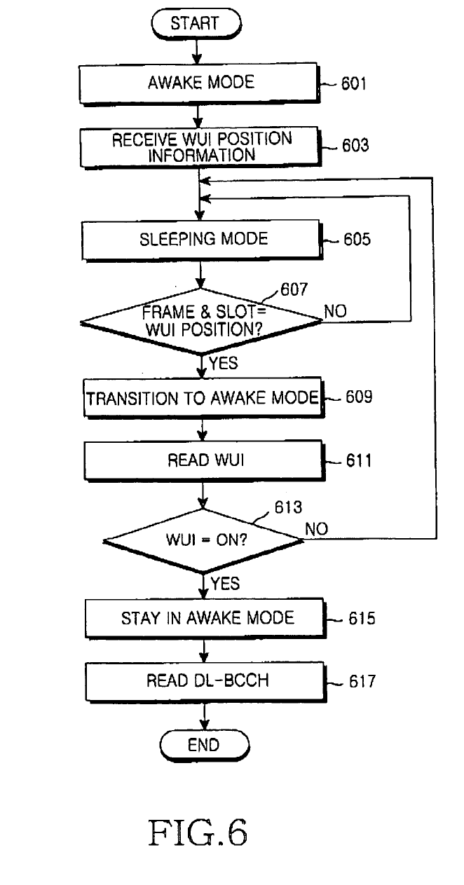

Reception of the DL-BCCH in the SS according to the present invention will be described with reference to FIG. 6, which is a flowchart illustrating a mode transition procedure in the sleeping state according to the present invention.

Referring to FIG. 6, the WUI of the DL-WUCH is used by the SS in order to determine whether to read the DL-BCCH.

The SS is in the awake mode in step 601 and receives WUI position information from the BS using one of the methods described earlier, in step 603. The SS checks the WUI position information and, in the absence of data to be sent or received, it transits to the sleeping mode in step 605. As compared to the prior art methods in which the SS periodically monitors the DL-BCCH, in the present invention, the SS determines whether to demodulate the DL-BCCH according to information contained within the WUI. Thus, the SS determines whether the frame and slot indexes of a received channel signal indicate the WUI position assigned to the SS by the BS in step 607. If they indicate the WUI position, the SS transits from the sleeping mode to the awake mode in step 609. Subsequently, the SS reads the received WUI in the awake mode in step 611.

The SS checks the value of the WUI in step 613. If the WUI is on (e.g., “1”), the SS stays in the awake mode and proceeds to in step 615. If the WUI is off (e.g., “0”), the SS transits to the sleeping mode and does not demodulate the DL-BCCH until receiving its WUI in step 605.

In the above procedure, the SS transits from the sleeping mode to the awake mode or stays in the sleeping mode depending on the WUI on the DL-WUCH that the SS monitors to determine the presence or absence of data on a control channel for the SS while the SS is in the sleeping mode of the sleeping state.

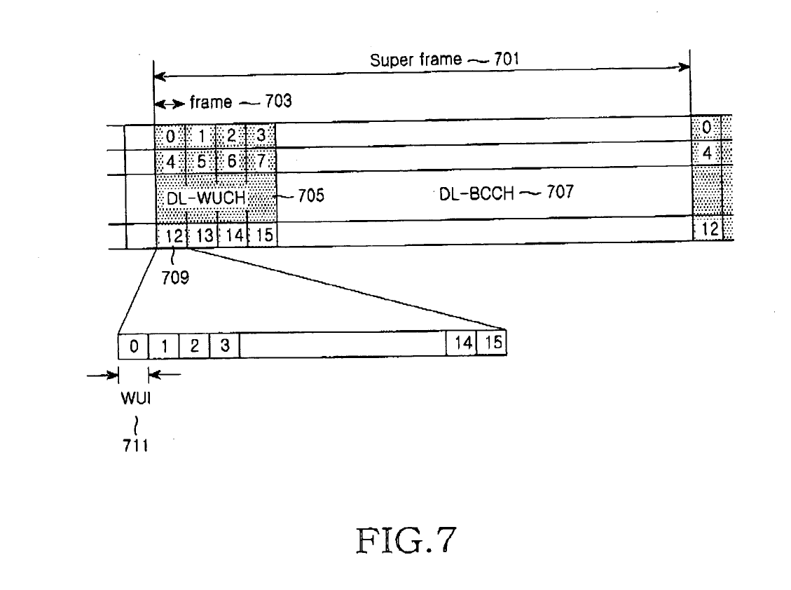

Two embodiments of mapping and transmission of the DL-WUCH in a DL frame will be described with reference to FIGS. 7 to 10. The DL-WUCH is time-multiplexed with the DL-BCCH for transmission, or the DL-WUCH and the DL-BCCH are simultaneously transmitted on different subcarriers.

First Embodiment-Time Multiplexing

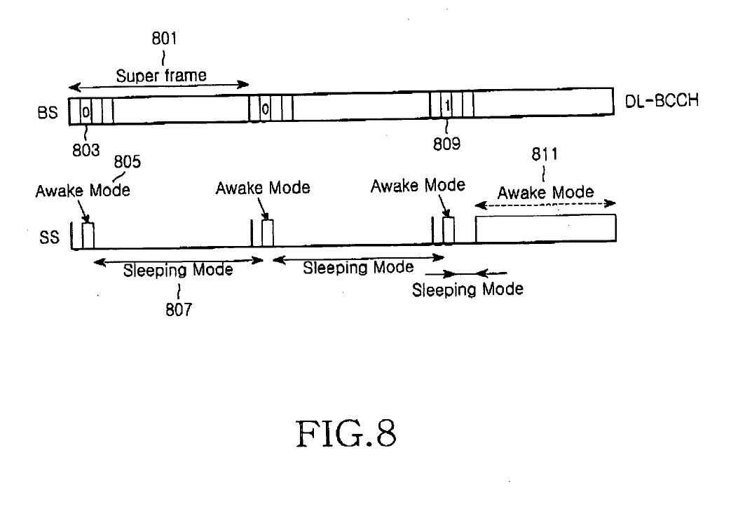

Transmission of the DL-WUCH and the DL-BCCH in time multiplexing will be described with reference to FIGS. 7 and 8.

FIG. 7 illustrates the structure of a frame in which the DL-WUCH and the DL-BCCH are multiplexed in time in an OFDMA scheme according to an embodiment of the present invention.

Referring to FIG. 7, in an OFDMA communication system compatible with an embodiment of the present invention a DL-BCCH 707 can be transmitted in a plurality of subfrequency bands. To reduce power consumption, the DL-BCCH 707 is transmitted using of a super frame 701 including an integer multiple of frames 703 (e.g. 64 frames). Thus, the transmission period of a DL-WUCH 705 is also one super frame. In FIG. 7, the horizontal axis represents time and the vertical axis represents frequency.

The position of a WUI 711 is identified by the index of a frame and the index of a time slot in the frame. In the case of time multiplexing as illustrated in FIG. 7, the DL-WUCH 705 preferably precedes the DL-BCCH 707 in time. The DL-WUCH 705 may occupy a plurality of subchannels. Also, the DL-WUCH 705 has a plurality of WUIs, each mapped to one OFDM symbol. As many WUIs as the maximum number of SSs can be set. That is, the WUIs can be mapped to SSs in a one-to-one correspondence.

For example, if one frame includes 16 OFDM symbols and each WI occupies one OFDM symbol, WUIs can be assigned to 16 SSs in one frame. In the illustrated case of FIG. 7, the DL-WUCH 705 precedes the DL-BCCH 707, including 16 frames. If the frame and slot information of a WUI assigned to an SS is 12 and 0, respectively, the SS reads its WUI by demodulating a first slot 711 of a 12^{th} frame 709.

If the WUI is on, the SS demodulates the following DL-BCCH 707, considering that broadcasting information exists for the SS. If the WUI is off, the SS does not demodulate the DL-BCCH 707 (which is contained in the current super frame 701), receives the DL-WUCH 705 in the next super frame 701, and repeats the above operation.

FIG. 8 illustrates mode transition of the SS that receives the time-multiplexed DL-WUCH and DL-BCCH illustrated in FIG. 7.

Referring to FIG. 8, the BS transmits the DL-BCCH to SSs on the basis of a super frame 801. In accordance with an embodiment of the present invention, the DL-WUCH precedes the DL-BCCH in time multiplexing. Meanwhile, the SS transits from the sleeping mode indicated by reference numeral 807 to the awake mode indicated by reference numeral 805 in a slot of a frame 803 having its assigned WUI, demodulates the DL-WUCH, and demodulates an OFDM symbol corresponding to the WUI.

If the WUI is off (e.g. 0) as indicated by reference numeral 803, the SS returns to the sleeping mode 807, not demodulating the following DL-BCCH. Then, the SS performs the above procedure on the next super frame 801.

On the contrary, if the WUI is on (e.g. 1) as indicated by reference numeral 809, the SS maintains the awake mode as indicated by reference numeral 811 and receives the DL-BCCH in the same super frame. Then, when the WUI is off, the SS returns to the sleeping mode. When reaching a slot of a frame having the WUI one super frame later, the SS transits to the awake mode indicated by reference numeral 811 and demodulates an OFDM symbol corresponding to the WUI.

Second Embodiment-Frequency Multiplexing

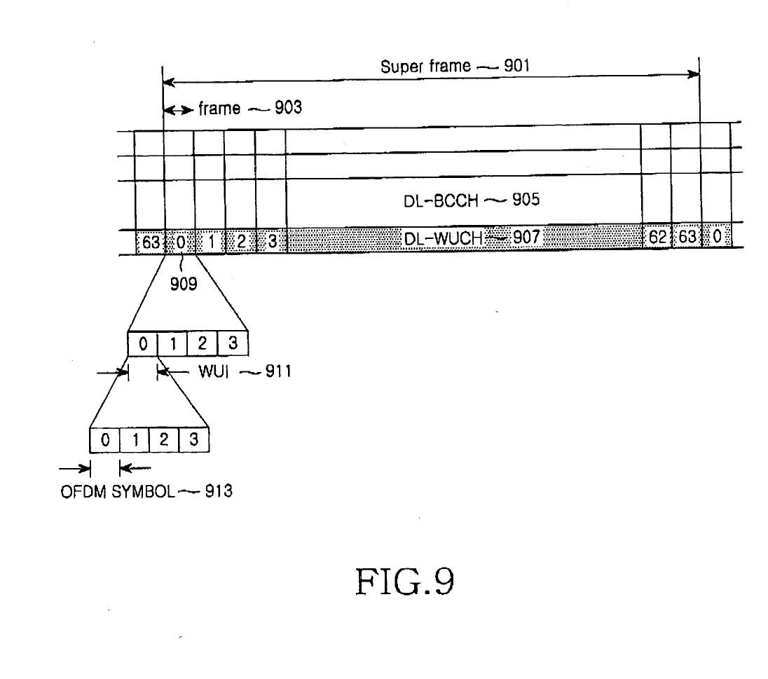

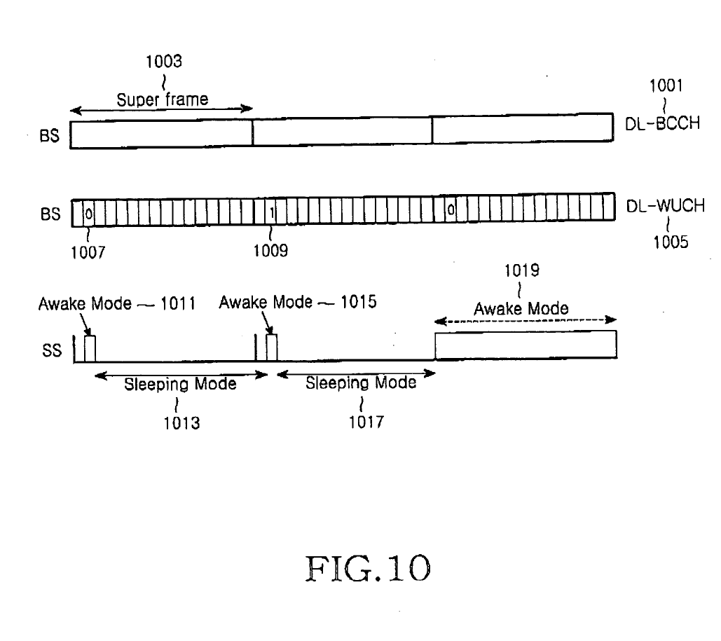

Transmission of the DL-WUCH and the DL-BCCH in frequency multiplexing according to another embodiment of the present invention will be described with reference to FIGS. 9 and 10.

FIG. 9 illustrates a frame structure in which the DL-WUCH and the DL-BCCH are delivered on independent subchannels in the OFDMA communication system according to the second embodiment of the present invention.

Referring to FIG. 9, an independent subchannel is assigned to the DL-WUCH. Compared to the time multiplexing method which is illustrated in FIG. 7, more frames are assigned to the DL-WUCH. Therefore, a WUI can occupy a plurality of OFDM symbols. The horizontal axis represents time and the vertical axis represents frequency.

As in the first embodiment of the present invention, a DL-BCCH 905 is transmitted on the basis of a super frame 901 having a plurality of frames 903 (e.g. 64 frames). A DL-WUCH 907 is multiplexed with the DL-BCCH 905 for the same time period, for transmission.

That is, the DL-BCCH 905 is delivered on a plurality of subcarriers in the whole super frame 901, and the DL-WUCH 907 is delivered using different subcarriers from those of the DL-BCCH 905 at the same time.

A WUI assigned to each SS in the DL-WUCH 907 is configured in an extended structure for the case where the DL-WUCH 907 transmits additional control information to the SS. That is, if one super frame has 64 frames and one frame includes 16 OFDM symbols, the super frame includes 1024 (64×16) OFDM symbols 913. Because it is inefficient to map each WUI to one OFDM symbol, each WUI preferably occupies a plurality of OFDM symbols (4 OFDM symbols are in FIG. 9) to contain more information.

As shown in FIG. 9, one WUI 911 is formed using four OFDM symbols 913 and thus WUIs 911 can be assigned to five SSs in one frame 909. Each SS demodulates its assigned WUI in a slot of a frame corresponding to its already received WUI position information and checks the value of the WUI.

If the WUI is on, the SS preferably receives the DL-BCCH in the next super frame because the DL-BCCH 905 is simultaneous with the DL-WUCH 907 in the current super frame 901. If the WUI is off, the SS demodulates the WUI of the DL-WUCH in the next super frame in the same manner.

FIG. 10 illustrates a mode transition of the SS in the sleeping state according to the second embodiment of the present invention. The BS transmits a DL-BCCH 1001 and a DL-WUCH 1005 on different subcarriers in each super frame 1003.

When the SS reaches a slot of a frame having its WUI in the sleeping mode, it transits to the awake mode as indicated by reference numeral 1011, demodulates the DL-WUCH, and reads an OFDM symbol corresponding to the WUI. If the WUI is off as indicated by reference numeral 1007, the SS returns to the sleeping mode indicated by reference numeral 1013 and waits until the next super frame. When reaching the slot of the frame having its WUI in the next super frame, the SS transits to the awake mode indicated by reference numeral 1015 and demodulates the OFDM symbol.

If the WUI is on as indicated by reference numeral 1009, which implies that the next super frame includes control information for the SS, the SS transits to the awake mode as indicated by reference numeral 1019 in the next super frame, and demodulates the DL-BCCH.

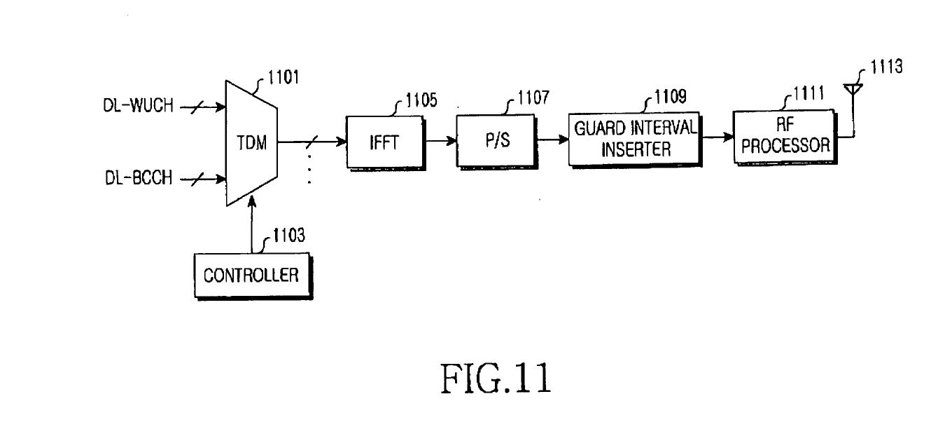

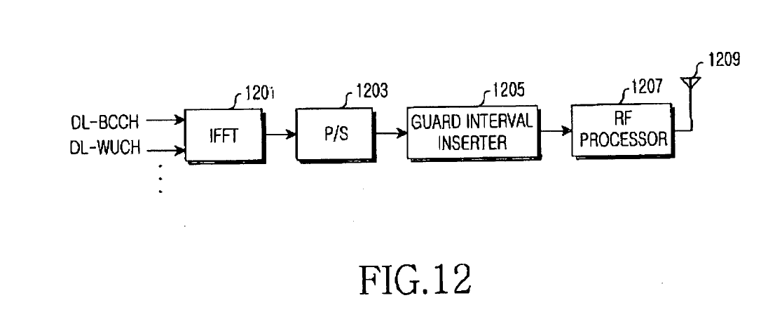

Now, a description will now be made of channel transmitting apparatuses for transmitting the DL-WUCH and WUI in the BS with reference to FIGS. 11 and 12.

FIG. 11 is a block diagram of a DL-WUCH transmitting apparatus in the BS according to the first embodiment of the present invention implemented as illustrated in FIGS. 7 and 8.

Referring to FIG. 11, a time division multiplexer (TDM) 1101 multiplexes the DL-WUCH and the DL-BCCH in time. A controller 1103 controls the operation of the TDM 1101 such that the DL-WUCH and the DL-BCCH are transmitted separately in time, each for a predetermined number of frames.

An inverse Fast Fourier transformer (IFFT) 1105 IFFT-processes the DL-WUCH or the DL-BCCH received from the TDM 1101. A parallel to serial (P/S) converter 1107 serializes the parallel IFFT signals received from the IFFT 1105. A guard interval inserter 1109 inserts a guard interval, for example, a cyclic prefix into the serial signal. A radio frequency (RF) processor 1111 processes the guard interval-including signal to an RF signal and transmits it to SSs through an antenna 1113.

It is obvious that the IFFT 1105 may additionally process channel signals other than the DL-WUCH and the DL-BCCH, for transmission.

FIG. 12 is a block diagram of a DL-WUCH transmitting apparatus in the BS according to the second embodiment of the present invention implemented as illustrated in FIGS. 9 and 10.

Referring to FIG. 12, since the DL-BCCH and the DL-WUCH are frequency-multiplexed and assigned to different channels, they are input in parallel to an IFFT 1201. That is, the DL-BCCH and the DL-WUCH are assigned different subcarriers and transmitted at the same time.

The IFFT 1201 IFFT-processes the DL-WUCH and the DL-BCCH. A P/S converter 1203 serializes the parallel IFFT signals received from the IFFT 1205. A guard interval inserter 1205 inserts a guard interval, for example, a cyclic prefix into the serial signal. An RF processor 1207 processes the guard interval-including signal to an RF signal and transmits it to SSs through an antenna 1209.

It is obvious that the IFFT 1203 may additionally process channel signals other than the DL-WUCH and the DL-BCCH, for transmission.

As described above, in the DL-WUCH transmitting apparatus and method for mode transition in the sleeping state in a BWA communication system according to the present invention, a frame structure is so configured as to support operations of the BS and the SS in a transition between the sleeping mode and the awake mode in the sleeping state. Therefore, calls can be efficiently transmitted and received between the BS and the SS and the power consumption of the SS is minimized.

While the invention has been shown and described with reference to certain preferred embodiments thereof, it will be understood by those skilled in the art that various changes in form and detail may be made therein without departing from the spirit and scope of the invention as defined by the appended claims.

1. In a broadband wireless communication system including a plurality of subscriber stations (SSs) and a base station (BS) that transmits control information to the SSs on a common control channel, a method of demodulating a control channel signal received from the BS in an SS, comprising the steps of:
receiving a wakeup channel signal indicating whether the control channel signal includes control information for the SS;
reading a wakeup channel-indicator (WUI) at a predetermined position within the wakeup channel signal
determining whether to demodulate the control channel signal according to information contained in the WUI.

2. The method of claim 1, wherein the WUI is included in the wakeup channel signal, indicating whether the SS is to wakeup.

3. The method of claim 1, wherein the determining step comprises the step of determining whether to demodulate the control channel signal depending on whether the WUI is on or off.

4. The method of claim 1, further comprising the step of transitioning from a sleeping mode to an awake mode depending on whether the WUI is on or off.

5. The method of claim 1, wherein the broadband wireless communication system has the following control channel configuration including the wakeup channel for effective monitoring of a control channel:

| PHY | Usage | Channel type |
|---|---|---|
| Broadcast control | System information | Common channel |
| channel (DL-BCCH) | and frame control | |
| | information | |
| Traffic control | Downlink traffic | Common channel |
| channel (DL-TCCH) | control information | |
| | and downlink | |
| | scheduling | |
| | information | |
| Wakeup channel (DL- | Awake mode | Common channel |
| WUCH) | indication | |

6. The method of claim 1, further comprising the step of receiving information about the position of the WUI in a message on a predetermined control channel.

7. The method of claim 6, wherein the wakeup channel indicator position information comprises one or more bits inserted in the message, indicating the index of a frame and the index of a slot in the frame.

8. The method of claim 1, further comprising the step of determining the position of the WUI according to the mapping relationship between the WUI position and a connection identifier (CID) which is assigned to the SS.

9. The method of claim 8, wherein the position of the WUI is an address indicated by the CID.

10. The method of claim 1, wherein the WUI is mapped to one or more symbols.

11. The method of claim 1, wherein the receiving step comprises the step of receiving the wakeup channel signal on one subcarrier.

12. The method of claim 1, wherein the wakeup channel signal and the control channel signal are time-multiplexed.

13. The method of claim 1, wherein the wakeup channel signal precedes the control channel signal in a predetermined control channel transmission period.

14. The method of claim 13, further comprising the step of demodulating the control channel signal in the same control channel transmission period if the WUI is on.

15. The method of claim 13, further comprising the step of transitioning to the sleeping mode if the WUI is off.

16. The method of claim 1, wherein the wakeup channel signal and the control channel signal are frequency-multiplexed and transmitted at the same time.

17. The method of claim 16, further comprising the step of demodulating the control channel signal in a next control channel transmission period WUI is on.

18. The method of claim 16, further comprising the step of transitioning to the sleeping mode if the WUI is off.

19. The method of claim 1, wherein the receiving step comprises the step of receiving the wakeup channel signal and a corresponding control channel signal for a predetermined transmission period.

20. The method of claim 19, wherein the transmission period comprises one or more frames.

21. The method of claim 20, wherein the transmission period comprises a super frame having 64 frames.

22. In an orthogonal frequency division multiple access (OFDMA) broadband wireless communication system where, in the absence of data to be sent between a base station (BS) and subscriber stations (SSs), the BS transmits a common control channel signal to the SSs every predetermined period in a sleeping state, an apparatus for transmitting the control channel signal in the BS, comprising:
a time-division multiplexer for time-multiplexing the control channel signal and a wakeup channel signal indicating whether the control channel signal includes control information for the SSs and outputting the time-multiplexed signals;
a controller for controlling the time-division multiplexer to selectively output the control channel signal and the wakeup channel signal at predetermined time points; and
an inverse fast Fourier transformer for inverse-fast-Fourier-transforming the control channel signal and the wakeup channel signal selectively received from the time-division multiplexer by mapping the received signal to a plurality of subcarriers.

23. The apparatus of claim 22, wherein the time-division multiplexer time-multiplexes the control channel signal and the wakeup channel signal, each being assigned a predetermined number of frames.

24. The apparatus of claim 22, wherein each of the control channel signal and the wakeup channel signal occupies one or more frames.

25. The apparatus of claim 24, wherein the control channel signal and the wakeup channel signal are transmitted periodically in a super frame having 64 frames.

26. The apparatus of claim 22, wherein the wakeup channel signal includes a plurality of wakeup channel indicators, each indicating whether the control channel signal contains control information for an SS.

27. The apparatus of claim 26, wherein each of the wakeup channel indicators is mapped to one symbol.

28. In an orthogonal frequency division multiple access (OFDMA) broadband wireless communication system where in the absence of data to be sent between a base station (BS) and subscriber stations (SSs), the BS transmits a common control channel signal to the SSs every predetermined period in a sleeping state, an apparatus for transmitting the control channel signal in the BS, comprising:
an inverse fast Fourier transformer for inverse-fast-Fourier-transforming the control channel signal and a wakeup channel signal by mapping the control channel signal and the wakeup channel signal to different subcarriers, each to at least one subcarrier.

29. The apparatus of claim 28, wherein the control channel signal and the wakeup channel signal are frequency-multiplexed in a predetermined number of frames.

30. The apparatus of claim 28, wherein each of the control channel signal and the wakeup channel signal occupies one or more frames.

31. The apparatus of claim 30, wherein the control channel signal and the wakeup channel signal are transmitted periodically in a super frame having 64 frames.

32. The apparatus of claim 28, wherein the wakeup channel signal includes a plurality of wakeup channel indicators, each indicating whether the control channel signal contains control information for an SS.

33. The apparatus of claim 32, wherein each of the wakeup channel indicators is mapped to one or more symbols.

34. The apparatus of claim 28, wherein the inverse-fast-Fourier-transformer maps the wakeup channel signal to one subcarrier.
